(19) United States
(12) Patent Application Publication
(10) Pub. No.: US 2013/0149016 A1
(43) Pub. Date: Jun. 13, 2013

(54) HYDROPHOBIC FLUORINATED NANO DIAMOND CONTAINING INTERMEDIATE TRANSFER MEMBERS

(71) Applicant: Xerox Corporation, Norwalk, CT (US)

(72) Inventor: Jin Wu, Pittsford, NY (US)

(73) Assignee: Xerox Corporation, Norwalk, CT (US)

(21) Appl. No.: 13/738,930

(22) Filed: Jan. 10, 2013

Related U.S. Application Data
(63) Continuation-in-part of application No. 12/431,801, filed on Apr. 29, 2009.

(51) Int. Cl. G03G 15/16

(52) U.S. Cl. CPC G03G 15/16
USPC 399/308

(57) ABSTRACT

An intermediate transfer media, such as a belt, that includes a fluorinated nano diamond of a fluorinated shell that encapsulates a synthetic diamond core with the shell containing at least 15 weight percent of graphite.

The present application is a Continuation-In-Part of copending U.S. application Ser. No. 12/431,801, filed on Apr. 29, 2009, the disclosure of the copending application being totally incorporated herein by reference. Also, the filing date or priority date of Apr. 29, 2009 for the copending application Ser. No. 12/431,801 is hereby claimed for the common subject matter contained in the present Continuation-In-Part application.

### CROSS REFERENCE TO RELATED APPLICATIONS

U.S. application Ser. No. 12/431,822, now U.S. Pat. No. 8,029,901, entitled Polyaryl Ether Copolymer Containing Intermediate Transfer Members, the disclosure of which is totally incorporated herein by reference, illustrates an intermediate transfer member comprised of a polyaryl ether.

Copending U.S. application Ser. No. 12/413,633, U.S. Publication, filed Mar. 30, 2009, entitled Fluorinated Sulfonic Acid Polymer Grafted Polyaniline Containing Intermediate Transfer Members, the disclosure of which is totally incorporated herein by reference, illustrates an intermediate transfer member comprised of a substrate, and in contact therewith a polyaniline having grafted thereto a fluorinated sulfonic acid polymer.

U.S. application Ser. No. 12/413,638, U.S. Publication No. 20100247918, filed Mar. 30, 2009, now U.S. Pat. No. 8,197,937, entitled Perfluoropolyether Polymer Grafted Polyaniline Containing Intermediate Transfer Members, the disclosure of which is totally incorporated herein by reference, illustrates an intermediate transfer member comprised of a substrate and in contact with the substrate a polyaniline grafted perfluoropolyether phosphoric acid polymer.

U.S. application Ser. No. 12/413,642, U.S. Publication 20100247919, filed Mar. 30, 2009, now U.S. Pat. No. 8,129,025, entitled Fluorotelomer Grafted Polyaniline Containing Intermediate Transfer Members, the disclosure of which is totally incorporated herein by reference, illustrates an intermediate transfer member comprised of a substrate, and a layer comprised of polyaniline having grafted thereto a fluorotelomer.

U.S. application Ser. No. 12/413,645, now U.S. Pat. No. 7,910,183, filed Mar. 30, 2009, entitled Layered Intermediate Transfer Members, the disclosure of which is totally incorporated herein by reference, illustrates an intermediate transfer member comprised of a polyimide substrate, and thereover a polyetherimide/polysiloxane.

Illustrated in U.S. application Ser. No. 12/129,995, now U.S. Pat. No. 8,005,410, filed May 30, 2008, entitled Polyimide Intermediate Transfer Components, the disclosure of which is totally incorporated herein by reference, is an intermediate transfer belt comprised of a substrate comprising a polyimide and a conductive component wherein the polyimide is cured at a temperature of from about 175 to about 290° C. over a period of time of from about 10 to about 120 minutes.

Illustrated in U.S. application Ser. No. 12/181,354, now U.S. Pat. No. 7,985,464, filed Jul. 29, 2008, entitled Core Shell Intermediate Transfer Components, the disclosure of which is totally incorporated herein by reference, is an intermediate transfer belt comprised of a substrate comprising a conductive core shell component.

Illustrated in U.S. application Ser. No. 12/360,324, U.S. Publication No. 20100190007, filed Jan. 27, 2009, now U.S. Pat. No. 8,202,607, entitled Nano Diamond Containing Intermediate Transfer Members, the disclosure of which is totally incorporated herein by reference, is an intermediate transfer member comprised of nano diamond.

### BACKGROUND

Disclosed are intermediate transfer members, and more specifically, intermediate transfer members useful in transferring a developed image in an electrostatographic, for example xerographic, including digital, image on image, and the like, machines or apparatuses, and printers. In embodiments, there are selected intermediate transfer members comprised of a fluorinated nano diamond, which is commercially available, comprised, for example, of a core shell structure with an inert diamond core and a fluorinated conductive graphite shell. In embodiments thereof, the fluorinated nano diamond is dispersed in or mixed with a suitable polymer, such as a polyimide or a polycarbonate.

A number of advantages are associated with the intermediate transfer members, such as belts (ITB) of the present disclosure, such as the use of fluorinated nano diamond which can be readily dispersed in both water and organic solvents primarily in view of the spectrum of functional chemical groups like carbon, oxygen, and nitrogen with directly linked carbon structures on the surface, and where the surface can be readily modified; an excellent maintained conductivity for extended time periods; dimensional stability; ITB humidity insensitivity for extended time periods; excellent dispensability in a polymeric solution; wear and abrasion resistance; and low and acceptable surface friction characteristics for improved transfer. More specifically, the surface fluorinated nano diamond intermediate transfer members, such as belts, disclosed possess, in embodiments thereof, improved mechanical properties as compared to similar devices that are free of a fluorinated nano diamond; a slippery surface and an excellent surface energy that permits complete or substantially complete image transfer from the intermediate member to a substrate; and also it is believed that the intermediate transfer members disclosed will, in embodiments, have good to excellent dimensional stability primarily in view of the water repelling characteristics of the member.

In a typical electrostatographic reproducing apparatus, a light image of an original to be copied is recorded in the form of an electrostatic latent image upon a photosensitive member, and the latent image is subsequently rendered visible by the application of electroscopic thermoplastic resin particles and colorant. Generally, the electrostatic latent image is developed by contacting it with a developer mixture, which usually comprises carrier granules having toner particles adhering triboelectrically thereto, or a liquid developer material, which may include a liquid carrier having toner particles dispersed therein. The developer material is advanced into contact with the electrostatic latent image, and the toner particles are deposited thereon in image configuration. Subsequently, the developed image is transferred to a copy sheet. It is advantageous to transfer the developed image to a coated intermediate transfer web, belt or component, and subsequently transfer with a high transfer efficiency the developed image from the intermediate transfer member to a permanent substrate. The toner image is subsequently usually fixed or fused upon a support, which may be the photosensitive member itself, or other support sheet such as plain paper.

In electrostatographic printing machines wherein the toner image is electrostatically transferred by a potential difference between the imaging member and the intermediate transfer member, the transfer of the toner particles to the intermediate transfer member and the retention thereof should be substantially complete so that the image ultimately transferred to the image receiving substrate will have a high resolution. Substantially about 100 percent toner transfer occurs when most or all of the toner particles comprising the image are transferred, and little residual toner remains on the surface from which the image was transferred.

Intermediate transfer members may possess a number of advantages, such as enabling high throughput at modest process speeds; improving registration of the final color toner image in color systems using synchronous development of one or more component colors and using one or more transfer stations; and increasing the number of substrates that can be selected. However, a disadvantage of using an intermediate transfer member is that a plurality of transfer operations is usually needed allowing for the possibility of charge exchange occurring between toner particles and the transfer member which ultimately can lead to less than complete toner transfer, resulting in low resolution images on the image receiving substrate, and image deterioration. When the image is in color, the image can additionally suffer from color shifting and color deterioration.

Attempts at controlling the resistivity of intermediate transfer members by, for example, adding conductive fillers, such as ionic additives and/or carbon black to the outer layer, are disclosed in U.S. Pat. No. 6,397,034 which describes the use of a treated carbon filler in a polyimide intermediate transfer member layer. However, there can be problems associated with the use of such fillers in that undissolved particles frequently bloom or migrate to the surface of the fluorinated polymer and cause imperfections to the polymer, thereby causing nonuniform resistivity, which in turn causes poor antistatic properties and poor mechanical strength characteristics. Also, ionic additives on the ITB surface may interfere with toner release. Furthermore, bubbles may appear in the polymer, some of which can only be seen with the aid of a microscope, and others of which are large enough to be observed with the naked eye resulting in poor or nonuniform electrical properties and poor mechanical properties.

In addition, the ionic additives themselves are sensitive to changes in temperature, humidity, and operating time. These sensitivities often limit the resistivity range. For example, the resistivity usually decreases by up to two orders of magnitude or more as the humidity increases from about 20 percent to 80 percent relative humidity. This effect limits the operational or process latitude.

Moreover, ion transfer can also occur in these systems. The transfer of ions leads to charge exchanges and insufficient transfers, which in turn causes low image resolution and image deterioration, thereby adversely affecting the copy quality. In color systems, additional adverse results include color shifting and color deterioration. Ion transfer also increases the resistivity of the polymer member after repetitive use. This can limit the process and operational latitude, and eventually the ion filled polymer member will be unusable.

Therefore, in embodiments, it is desired to provide an intermediate transfer member, which has excellent transfer capabilities; is conductive, and more specifically, has improved conductivity or resistivity as compared, for example, to an intermediate transfer member where a fluorinated nano diamond is absent; and possesses excellent humidity insensitivity characteristics leading to high copy quality where developed images with minimal resolution issues can be obtained. It is also desired to provide a weldable intermediate transfer belt that may not, but could, have puzzle cut seams, and instead, has a weldable seam, thereby providing a belt that can be manufactured without labor intensive steps, such as manually piecing together the puzzle cut seam with fingers, and without the lengthy high temperature and high humidity conditioning steps. It is also desired to provide an intermediate transfer member, which has excellent wear and abrasion resistance, and more specifically, has improved mechanical properties as compared, for example, to an intermediate transfer member where a fluorinated nano diamond is absent.

### REFERENCES

Illustrated in U.S. Pat. No. 7,031,647 is an imageable seamed belt containing a lignin sulfonic acid doped polyaniline.

Illustrated in U.S. Pat. No. 7,139,519 is an intermediate transfer belt comprising a belt substrate comprising primarily at least one polyimide polymer, and a welded seam.

Illustrated in U.S. Pat. No. 7,130,569 is a weldable intermediate transfer belt comprising a substrate comprising a homogeneous composition comprising a polyaniline in an amount of, for example, from about 2 to about 25 percent by weight of total solids, and a thermoplastic polyimide present in an amount of from about 75 to about 98 percent by weight of total solids, wherein the polyaniline has a particle size of, for example, from about 0.5 to about 5 microns.

Puzzle cut seam members are disclosed in U.S. Pat. Nos. 5,487,707; 6,318,223, and 6,440,515.

Illustrated in U.S. Pat. No. 6,602,156 is a polyaniline filled polyimide puzzle cut seamed belt, however, the manufacture of a puzzle cut seamed belt is usually labor intensive and costly, and the puzzle cut seam, in embodiments, is sometimes weak. The manufacturing process for a puzzle cut seamed belt usually involves a lengthy in time high temperature and a high humidity conditioning step. For the conditioning step, each individual belt is rough cut, rolled up, and placed in a conditioning chamber that is environmentally controlled at about 45° C. and about 85 percent relative humidity for approximately 20 hours. To prevent or minimize condensation and watermarks, the puzzle cut seamed transfer belt resulting is permitted to remain in the conditioning chamber for a suitable period of time, such as 3 hours. The conditioning of the transfer belt renders it difficult to automate the manufacturing thereof, and the absence of such conditioning may adversely impact the belts electrical properties, which in turn results in poor image quality.

It is known that carbon can be used as the conductive particles in several intermediate transfer belts, however, carbon can be difficult to disperse since there are very few polar groups on the surface, and unless they are specially modified on the surface. Also, it can be difficult to generate carbon black based ITBs with consistent resistivity because the required loading is present on the vertical part of the percolation curve and the working window for carbon black is very narrow, and is difficult for a robust manufacturing process. In addition, in humid environments, moisture will tend to deposit on the ITB during idle and cause wrinkles induced transfer failures and print defects. Thus a more hydrophobic ITB is desirable for both excellent dimensional stability and high fidelity transfer since the hydrophobic ITB is usually of low surface energy and repels water.

### SUMMARY

In embodiments, there is disclosed an intermediate transfer member comprised of a substrate comprising a fluorinated nano diamond; an intermediate transfer member, such as an intermediate belt comprised of a substrate comprising a fluorinated nano diamond; an intermediate transfer member wherein the resistivity thereof is from about 10⁶ to about 10¹³ ohm/square, from about 10⁸ to about 10¹² ohm/square, and more specifically, from about 10⁹ to about 10¹¹ ohm/square.

There is disclosed an intermediate transfer member comprised of a substrate comprising fluorinated nano diamonds with an excellent maintained resistivity for extended time periods. More specifically, there is almost no change in the intermediate transfer member surface resistivity with, for example, an intermediate transfer member comprised of a substrate comprising a fluorinated nano diamond.

In embodiments, there is disclosed an intermediate transfer member comprised of a substrate comprising fluorinated nano diamonds, and which member possesses excellent wear and abrasion resistance.

In embodiments, there is disclosed an intermediate transfer member comprised of a substrate comprising fluorinated nano diamonds, and which member has a low friction coefficient, thereby permitting a desirable slippery surface.

In addition, the present disclosure provides, in embodiments, an apparatus for forming images on a recording medium comprising a charge retentive surface to receive an electrostatic latent image thereon; a development component to apply toner to the charge retentive surface to develop the electrostatic latent image and to form a developed image on the charge retentive surface; a weldable intermediate transfer belt to transfer the developed image from the charge retentive surface to a substrate, and a fixing component.

### DETAILED DESCRIPTION

Aspects of the present disclosure relate to an intermediate transfer member comprised of a fluorinated nano diamond; a transfer media comprised of a fluorinated nano diamond, and wherein the fluorinated nano diamond is comprised of a diamond core, and a graphite shell, the surface of which has been fluorinated wherein in embodiments shell refers, for example, to the core being completely, about 100 percent, encapsulated or encased by the shell, and where the amount of graphite in the shell is from about 15 to about 40 weight percent, from about 17 to about 35 weight percent, from about 20 to about 35 weight percent, or from about 23 to about 27 weight percent, and the fluorine content or the amount of fluorine in the shell is from about 60 to about 85, from about 65 to about 83, from about 65 to about 80, or from about 73 to about 77 weight percent based on the shell ingredients of the graphite and the fluorine being equal to about 100; an intermediate transfer member consisting of a conductive component, and a synthetic diamond core and a fluorinated graphite shell thereover that fully, 100 percent, encapsulates the core, and wherein the shell contains from about 60 to about 85 weight percent of fluorine and from about 15 to about 40 weight percent of graphite, and wherein the total of the shell components of fluorine and graphite is equal to about 100; an intermediate transfer member consisting of a conductive component of carbon black or a polyaniline, and a fluorinated nano diamond, wherein the fluorinated nano diamond consists of a diamond core and a fluorinated graphite shell, and wherein the diamond core is present in an amount of from about 20 to about 99.9 weight percent of total solids, the fluorinated nano diamond possesses a fluorine content of from about 60 to about 85 weight percent, and a graphite content of from about 15 to about 30 weight percent, and wherein the diamond core and the fluorinated graphite shell are optionally dispersed in a polymer of at least one of a polyimide, a polycarbonate, a polyester, a poly(butylene terephthalate), a poly(ethylene terephthalate), a poly(ethylene naphthalate), a polyvinylidene fluoride, a polysulfone, a polyetherimide, a polyamideimide, and a polyethylene-co-polytetrafluoroethylene; an intermediate transfer member consisting of a supporting substrate and thereover a coating consisting of a conductive component of carbon black or a polyaniline, and a fluorinated nano diamond, wherein said fluorinated nano diamond consists of a diamond core and a fluorinated graphite shell, and wherein said diamond core is present in an amount of from about 20 to about 99.9 weight percent of total solids, said fluorinated nano diamond possesses a fluorine content of from about 60 to about 85 weight percent, and a graphite content of from about 15 to about 30 weight percent, and wherein said diamond core and said fluorinated graphite shell are optionally dispersed in a polymer of at least one of a polyimide, a polycarbonate, a polyester, a poly(butylene terephthalate), a poly(ethylene terephthalate), a poly(ethylene naphthalate), a polyvinylidene fluoride, a polysulfone, a polyetherimide, a polyamideimide, and a polyethylene-co-polytetrafluoroethylene, and an apparatus for forming images on a recording medium comprising a charge retentive surface to receive an electrostatic latent image thereon; a development component to apply toner to the charge retentive surface to develop the electrostatic latent image, and to form a developed image on the charge retentive surface; an intermediate transfer member comprised of a substrate comprising a fluorinated nano diamond or a mixture of fluorinated nano diamonds; an intermediate transfer member consisting of a supporting substrate and thereover a coating consisting of a conductive component of carbon black or a polyaniline, and a fluorinated nano diamond, wherein said fluorinated nano diamond consists of a diamond core and a fluorinated graphite shell, and wherein said diamond core is present in an amount of from about 20 to about 99.9 weight percent of total solids, said fluorinated nano diamond possesses a fluorine content of from about 60 to about 85 weight percent, and a graphite content of from about 15 to about 30 weight percent, and wherein said diamond core and said fluorinated graphite shell are optionally dispersed in a polymer of at least one of a polyimide, a polycarbonate, a polyester, a poly(butylene terephthalate), a poly(ethylene terephthalate), a poly(ethylene naphthalate), a polyvinylidene fluoride, a polysulfone, a polyetherimide, a polyamideimide, and a polyethylene-co-polytetrafluoroethylene, and which member has a water contact angle of from about 80 to about 90 or from about 80 to about 85 degrees, and a coefficient of from about 25 to about 35, or from about 30 to about 35; a xerographic intermediate transfer member comprised of a fluorinated nano diamond of a diamond core and a fluorinated graphite shell thereover, and an optional polymer binder, and wherein the shell contains from about 60 to about 85 weight percent of fluorine and from about 15 to about 40 weight percent of graphite.

The fluorinated nano diamond comprises, in embodiments, a core-shell structure, where the shell fully surrounds the core, that is the core is covered on its surface or encapsulated with 100 percent of the shell, with a sp³ diamond core and sp² graphite envelop with a fluorinated surface. Fluorinated nano diamond can be obtained from the fluorination of nano diamond with elemental fluorine at elevated temperatures such as from about 150° C. to about 600° C. A diluent such as nitrogen is admixed with the fluorine. The nature and properties of the fluorinated nano diamond can vary depending, for example, on the particular nano diamond source, the conditions of the reaction, and with the degree of fluorination obtained in the final product. The degree of fluorination in the final product may be varied by changing the process reaction conditions, principally temperature and time. Generally, the higher the temperature and the longer the time, the higher the fluorine content.

One form of fluorinated nano diamond, which is suitable for use in accordance with the present disclosure, is comprised of a polycarbon monofluoride, CFₓ graphite shell and a diamond core, where the core is 100 percent, or fully encapsulated by the shell, that is the shell forms a continuous coating on the core and surrounds the entire core, with the fluorine content plus the graphite content in the fluorinated graphite shell being about 100 percent. More specifically, the amount of fluorine in the fluorinated graphite shell is from about 85 to about 60 weight percent, from about 83 to about 65 weight percent, from about 80 to about 65 weight percent, from about 77 to about 73 weight percent, and where the amount of graphite in the shell is from about 15 to about 40 weight percent, from about 17 to about 35 weight percent, from about 20 to about 35 weight percent, or from about 23 to about 27 weight percent, based on the ingredients of the graphite and the fluorine being equal to 100 percent, wherein x represents the number of fluorine atoms and generally is from 0.005 to about 1.5, from about 0.01 to about 1.5, or from about 0.04 to about 1.4. The formula CFₓ has a lamellar structure composed of layers of fused six carbon rings with fluorine atoms attached to the carbons and lying above and below the plane of the carbon atoms. Generally, formation of this type of fluorinated nano diamond involves reacting nano diamond with F₂ catalytically.

Another form of fluorinated nano diamond, which is suitable for use in accordance with the present disclosure, is comprised of a poly(dicarbon monofluoride), C₂F_{y} graphite shell and a diamond core, wherein y represents the number of fluorine atoms, and generally is up to about 1.5, from about 0.01 to about 1.5, or from about 0.04 to about 1.4, and where the core is 100 percent, or fully encapsulated by the shell, that is the shell forms a continuous coating on the core and surrounds the entire core with the fluorine content plus the graphite content in the fluorinated graphite shell being about 100. More specifically, the amount of fluorine in the fluorinated graphite shell is from about 85 to about 60 weight percent, from about 83 to about 65 weight percent, from about 80 to about 65 weight percent, or from about 77 to about 73 weight percent, and where the amount of graphite in the shell is from about 15 to about 40 weight percent, from about 17 to about 35 weight percent, from about 20 to about 35 weight percent, or from about 23 to about 27 weight percent based on the ingredients of the graphite and the fluorine being equal to 100.

The fluorinated nano diamond can be used alone or in combination with other carbon phases such as carbon black or acetylene black, and the polymeric binder used to disperse these conductive particles can be, for example, a polyimide (thermosetting or thermoplastic), or other polymers including polycarbonate, polyamidimide, polyphenylene sulfide, polyamide, polysulfone, polyetherimide, polyester such as polybutylene terephthalate (PBT), polyethylene naphthalate (PEN) or polyester copolymer, poly(vinylidene fluoride) (PVDF), polyethylene-co-polytetrafluoroethylene, their blends, and the like. The intermediate transfer members can be extrusion processed or solution/dispersion processed.

Nano diamond is believed to be a unique material generated by the detonation of a diamond blend and subsequently chemical purification. Nano diamond is considered unique in its particle size and shape; for example, the diameter of a diamond crystal is on the average of about 5 nanometers (surface area is about 270 to 380 m²/g, and the average grain size from about 20 to about 50 nanometers). The unique nano diamond rounded shape offers excellent dispersibility and superior lubricity characteristics with the hardness and wear resistance of diamond, and it is also thermally conductive.

The nano diamond surface includes a spectrum of functional chemical groups (C is about 76 percent, O is about 6 percent, and N is about 10 percent) with directly linked carbon structures, thus rendering it electrically conductive. The surfaces are chemically tunable for improved characteristics. One of the modified surfaces comprises fluorination.

The fluorinated nano diamond is present in an amount of from about 3 to about 30, from about 1 to about 30, from about 5 to about 20, or from about 10 to about 15 weight percent based on the intermediate transfer member components.

Fluorinated nano diamond comprises, in embodiments, a diamond core present in an amount of from, for example, about 40 to about 99.9 weight percent, from about 50 to about 98 weight percent, or from about 70 to about 95 weight percent, and a fluorinated graphite shell, present in an amount of, for example, from about 0.1 to about 60 weight percent, from about 2 to about 50 weight percent, or from about 5 to about 30 weight percent. The shell fluorine content in the fluorinated nano diamond is, for example, from about 60 to about 85 weight percent, and where the graphite is present in an amount of from about 15 to about 40 weight percent.

Fluorinated nano diamonds comprise, for example, a core shell structure with a hard and inert diamond core and a conductive graphite shell, where the graphite shell surface includes a fluorinated surface, and where the core is 100 percent, or fully encapsulated by the shell, that is the shell forms a continuous coating on the core and substantially surrounds the entire core. More specifically, fluorinated nano diamond can be prepared by the detonation of a diamond blend of synthetic and/or natural diamond, and subsequently, by chemical purification followed by fluorination with the diameter of diamond crystals being, for example, from about 1 to about 10 nanometers, and specifically, with an average diameter of about 5 nanometers; a B.E.T. surface area that is from about 270 to about 380 square meters per gram, with an average grain size of from about 20 to about 50 nanometers; and with a unique rounded shape that provides excellent lubricity characteristics with the hardness and wear resistance of diamond.

Fluorinated nano diamonds are commercially available from NANOBLOX, Inc. For example, commercially available fluorinated nano diamond possesses about 50 weight percent of a diamond core and about 50 weight percent of a graphite shell, which shell is from about 60 to about 85 percent fluorinated, and wherein the shell includes from about 15 to about 40 weight percent of graphite; and a fluorinated nano diamond which possesses about 90 weight percent of a diamond core and about 10 weight percent of a graphite shell, which shell contains about 70 weight percent of fluorine and about 30 weight percent of graphite.

Examples of additional components present in the intermediate transfer member are a number of known polymers and conductive components.

Examples of the polymeric binders selected to disperse the fluorinated nano diamond include, for example, polyimides (thermosetting or thermoplastic), polyaramide, polyphthalamide, fluorinated polyimide, polyimidesulfone polycarbonate, polyamideimide (PAI), polysulfone, polyetherimide, poly(ethylene terephthalate) (PET), poly(ethylene naphthalate) (PEN), poly(butylene terephthalate) (PBT), polyvinylidene fluoride (PVDF), and polyethylene-co-polytetrafluoroethylene.

Examples of rapidly cured polyimide polymers selected in the binder are, for example, VTEC™ PI 1388, 080-051, 851, 302, 203, 201 and PETI-5, all available from Richard Blaine International, Incorporated, Reading, Pa. These thermosetting polyimides are cured at suitable temperatures, and more specifically, from about 180° C. to about 260° C. over a short period of time, such as, for example, from about 10 to about 120 minutes, and from about 20 to about 60 minutes; possess, for example, a number average molecular weight of from about 5,000 to about 500,000, or from about 10,000 to about 100,000, and a weight average molecular weight of from about 50,000 to about 5,000,000, or from about 100,000 to about 1,000,000. Also, there can be selected as the binder thermosetting polyimide precursors that are usually cured at higher temperatures (above 300° C.) than the VTEC™ PI polyimide precursors, and which higher temperature cured precursors include, for example, PYRE-M.L® RC-5019. RC-5057, RC-5069, RC-5097, RC-5053, and RK-692, all commercially available from Industrial Summit Technology Corporation, Parlin, N.J.; RP-46 and RP-50, both commercially available from Unitech LLC, Hampton, Va.; DURIMIDE® 100 commercially available from FUJIFILM Electronic Materials U.S.A., Inc., North Kingstown, R.I.; and KAPTON® HN, VN and FN, commercially available from E.I. DuPont, Wilmington, Del.; and present, for example, in amounts of, for example, from about 70 to about 97, or from about 80 to about 95 weight percent of the intermediate transfer member components.

The polyimides may be synthesized from prepolymer solutions such as polyamic acid or esters of polyamic acid, or by the reaction of a dianhydride and a diamine. Suitable dianhydrides include aromatic dianhydrides and aromatic tetracarboxylic acid dianhydrides such as, for example, 9,9-bis(trifluoromethyl)xanthene-2,3,6,7-tetracarboxylic acid dianhydride, 2,2-bis-(3,4-dicarboxyphenyl)-hexafluoropropane dianhydride, 2,2-bis((3,4-dicarboxyphenoxy)phenyl)-hexafluoropropane dianhydride, 4,4′-bis(3,4-dicarboxy-2,5,6-trifluorophenoxy)octafluorobiphenyl dianhydride, 3,3′,4,4′-tetracarboxybiphenyl dianhydride, 3,3′,4,4′-tetracarboxybenzophenone dianhydride, di-(4-(3,4-dicarboxyphenoxy)phenyl)-ether dianhydride, di-(4-(3,4-dicarboxyphenoxy)phenyl)-sulfide dianhydride, di-(3,4-dicarboxyphenyl)methane dianhydride, di-(3,4-dicarboxyphenyl)-ether dianhydride, 1,2,4,5-tetracarboxybenzene dianhydride, 1,2,4-tricarboxybenzene dianhydride, butanetetracarboxylic dianhydride, cyclopentanetetracarboxylic dianhydride, pyromellitic dianhydride, 1,2,3,4-benzenetetracarboxylic dianhydride, 2,3,6,7-naphthalenetetracarboxylic dianhydride, 1,4,5,8-naphthalenetetracarboxylic dianhydride, 1,2,5,6-naphthalenetetracarboxylic dianhydride, 3,4,9,10-perylenetetracarboxylic dianhydride, 2,3,6,7-anthracenetetracarboxylic dianhydride, 1,2,7,8-phenanthrenetetracarboxylic dianhydride, 3,3′,4,4′-biphenyltetracarboxylic dianhydride, 2,2′,3,3′-biphenyltetracarboxylic dianhydride, 3,3′,4-4′-benzophenonetetracarboxylic dianhydride, 2,2′,3,3′-benzophenonetetracarboxylic dianhydride, 2,2-bis(3,4-dicarboxyphenyl)propane dianhydride, 2,2-bis(2,3-dicarboxyphenyl)propane dianhydride, bis(3,4-dicarboxyphenyl)ether dianhydride, bis(2,3-dicarboxyphenyl)ether dianhydride, bis(3,4-dicarboxyphenyl)sulfone dianhydride, bis(2,3-dicarboxyphenyl)sulfone 2,2-bis(3,4-dicarboxyphenyl)-1,1,1,3,3,3-hexafluoropropane dianhydride, 2,2-bis(3,4-dicarboxyphenyl)-1,1,1,3,3,3-hexachloropropane dianhydride, 1,1-bis(2,3-dicarboxyphenyl)ethane dianhydride, 1,1-bis(3,4-dicarboxyphenyl)ethane dianhydride, bis(2,3-dicarboxyphenyl)methane dianhydride, bis(3,4-dicarboxyphenyl)methane dianhydride, 4,4′-(p-phenylenedioxy)-diphthalic dianhydride, 4,4′-(m-phenylenedioxy)diphthalic dianhydride, 4,4′-diphenylsulfidedioxybis(4-phthalic acid)dianhydride, 4,4′-diphenylsulfonedioxybis(4-phthalic acid)dianhydride, methylenebis(4-phenyleneoxy-4-phthalic acid)dianhydride, ethylidenebis(4-phenyleneoxy-4-phthalic acid)dianhydride, isopropylidenebis-(4-phenyleneoxy-4-phthalic acid)dianhydride, hexafluoroisopropylidenebis-(4-phenyleneoxy-4-phthalic acid)dianhydride, and the like. Exemplary diamines suitable for use in the preparation of the polyimide include aromatic diamines such as 4,4′-bis-(m-aminophenoxy)-biphenyl, 4,4′-bis-(m-aminophenoxy)-diphenyl sulfide, 4,4′-bis-(m-aminophenoxy)-diphenyl sulfone, 4,4′-bis-(p-aminophenoxy)-benzophenone, 4,4′-bis-(p-aminophenoxy)-diphenyl sulfide, 4,4′-bis(p-aminophenoxy)-diphenyl sulfone, 4,4′-diamino-azobenzene, 4,4′-diaminobiphenyl, 4,4′-diaminodiphenyl sulfone, 4,4′-diamino-p-terphenyl, 1,3,-bis-(gamma-aminopropyl)-tetramethyl-disiloxane, 1,6-diaminohexane, 4,4′-diamino diphenylmethane, 3,3′-diaminodiphenylmethane, 1,3,-diaminobenzene, 4,4′-diaminodiphenyl ether, 2,4′-diaminodiphenylether, 3,3′-diaminodiphenylether, 3,4′-diaminodiphenylether, 1,4-diaminobenzene, 4,4′-diamino-2,2′,3,3′,5,5′,6,6′-octafluoro-biphenyl, 4,4′-diamino-2,2′,3,3′,5,5′,6,6′-octafluorodiphenyl ether, bis[4-(3-aminophenoxy)-phenyl]sulfide, bis[4-(3-aminophenoxy)phenyl]sulfone, bis[4-(3-aminophenoxy)phenyl] ketone, 4,4′-bis(3-aminophenoxy)biphenyl, 2,2-bis[4-(3-aminophenoxy)phenyl] propane, 2,2-bis[4-(3-aminophenoxy)phenyl]-1,1,1,3,3,3-hexafluoropropane, 4,4′-diaminodiphenyl sulfide, 4,4′-diaminodiphenyl ether, 4,4′-diaminodiphenyl sulfone, 4,4′-diaminodiphenylmethane, 1,1-di(p-aminophenyl)ethane, 2,2-di(p-aminophenyl)propane, and 2,2-di(p-aminophenyl)-1,1,1,3,3,3-hexafluoropropane.

The dianhydrides and diamines can be selected in a weight ratio of dianhydride to diamine of from about 20:80 to about 80:20, or about a 50:50 weight ratio. The above aromatic dianhydride (aromatic tetracarboxylic acid dianhydride) and diamine (aromatic diamine) are used singly or as a mixture, respectively. The polyimide can be prepared from the dianhydride and diamine by known methods. For example, the dianhydride and the diamine can be suspended or dissolved in an organic solvent as a mixture or separately, and can be reacted to form the polyamic acid, which is thermally or chemically dehydrated; then the product is separated and purified. The polyimide is heat melted with a known extruder, delivered in the form of a film from a die having a slit nozzle, and a static charge is applied to the film, the film is cooled and solidified with a cooling roller having a surface temperature in the range of glass transition temperature (T_{g}) of the polymer (T_{g})-50° C. to (T_{g})-15° C., transmitted under tension without bringing the film into contact with rollers while further cooling to the room temperature, and wound up or transferred in a further step.

Further, polyimides that may be selected may be prepared as fully imidized polymers which do not contain any “amic” acid, and do not require high temperature cure to convert them to the imide form. A typical polyimide of this type may be prepared by reacting di-(2,3-dicarboxyphenyl)-ether dianhydride with 5-amino-1-(p-aminophenyl)-1,3,3-trimethylindane. This polymer is available as Polyimide XU 218 sold by Ciba-Geigy Corporation, Ardsley, N.Y. Other fully imidized polyimides are available from Lenzing Corporation in Dallas, Tex., and are sold as Lenzing P83 polyimide and by Mitsui Toatsu Chemicals, New York, N.Y. sold as Larc-TPI.

Examples of specific selected thermoplastic polyimide binders are KAPTON® KJ, commercially available from E.I. DuPont, Wilmington, Del., as represented by

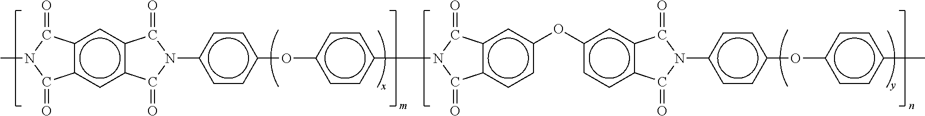

wherein x is equal to 2; y is equal to 2; m and n are from about 10 to about 300; and IMIDEX®, commercially available from West Lake Plastic Company, as represented by

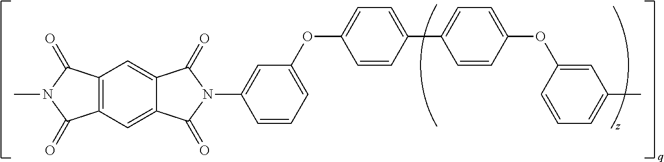

wherein z is equal to 1, and q is from about 10 to about 300.

Examples of polycarbonate binders selected include poly(4,4′-isopropylidene-diphenylene)carbonate (also referred to as bisphenol-A-polycarbonate), poly(4,4′-cyclohexylidine diphenylene)carbonate (also referred to as bisphenol-Z-polycarbonate), poly(4,4′-isopropylidene-3,3′-dimethyl-diphenyl)carbonate (also referred to as bisphenol-C-polycarbonate), and the like. In embodiments, the intermediate transfer member binders are comprised of bisphenol-A-polycarbonate resins, commercially available as MAKROLON®, with, for example, a weight average molecular weight of from about 50,000 to about 500,000.

Examples of additional components present in the intermediate transfer member are a number of known conductive components present in an amount of from about 3 to about 20 weight percent such as polyaniline and carbon black. In embodiments, the polyaniline component has a relatively small particle size of, for example, from about 0.5 to about 5, from about 1.1 to about 2.3, from about 1.2 to about 2, from about 1.5 to about 1.9, or about 1.7 microns.

Specific examples of polyanilines selected for the transfer member, such as an ITB, are PANIPOL™ F, commercially available from Panipol Oy, Finland; and lignosulfonic acid grafted polyanilines.

Examples of the intermediate transfer member carbon blacks include VULCAN® carbon blacks, REGAL® carbon blacks, and BLACK PEARLS® carbon blacks available from Cabot Corporation. Specific examples of conductive carbon blacks are BLACK PEARLS® 1000 (B.E.T. surface area=343 m²/g, DBP absorption=105 ml/g), BLACK PEARLS® 880 (B.E.T. surface area=240 m²/g, DBP absorption=106 ml/g), BLACK PEARLS® 800 (B.E.T. surface area=230 m²/g, DBP absorption=68 ml/g), BLACK PEARLS® L (B.E.T. surface area=138 m²/g, DBP absorption=61 ml/g), BLACK PEARLS® 570 (B.E.T. surface area=110 m²/g, DBP absorption=114 ml/g), BLACK PEARLS® 170 (B.E.T. surface area=35 m²/g, DBP absorption=122 ml/g), VULCAN® XC72 (B.E.T. surface area=254 m²/g, DBP absorption=176 ml/g), VULCAN® XC72R (fluffy form of VULCAN® XC72), VULCAN® XC605, VULCAN® XC305, REGAL® 660 (B.E.T. surface area=112 m²/g, DBP absorption=59 ml/g), REGAL® 400 (B.E.T. surface area=96 m²/g, DBP absorption=69 ml/g), and REGAL® 330 (B.E.T. surface area=94 m²/g, DBP absorption=71 ml/g). Dibutyl phthalate (DBP) absorption by the voids within carbon blacks are used to measure the structure of carbon black. The higher the structure, the more the voids, and the higher the DBP absorption.

For example, the fluorinated nano diamond can be dispersed in a rapid curing thermosetting polyimide/N-methyl-2-pyrrolidone (NMP) solution, and then the dispersion can be applied to or coated on a glass plate using known draw bar coating methods. The resulting film or films can be dried at high temperatures, such as from about 100 to about 400° C., from about 150 to about 300° C., or from about 175 to about 200° C. for a sufficient period of time, such as for example, from about 20 to about 180 minutes, or from about 75 to about 100 minutes while remaining on the glass plate. After drying and cooling to room temperature, the film or films on the glass plate or separate glass plates are immersed into water overnight, about 18 to 23 hours, and subsequently, the about 50 to about 150 microns thick film of films formed are released from the glass resulting in the functional intermediate transfer member or members as disclosed herein.

In embodiments, the fluorinated nano diamond can be dispersed in a bisphenol-A-polycarbonate/methylene chloride (CH₂Cl₂) solution, and then the dispersion can be applied to or coated on a biaxially oriented poly(ethylene naphthalate) (PEN) substrate (KALEDEX™ 2000) having a known thickness of, for example, about 3.5 mils using known draw bar coating methods. The resulting film or films can be dried at high temperatures, such as from about 100° C. to about 200° C., or from about 120° C. to about 160° C. for a sufficient period of time, such as for example, from about 1 to about 30 minutes, or from about 5 to about 15 minutes while remaining on the PEN substrate. After drying and cooling to room temperature, about 23° C. to about 25° C., the film or films on the PEN substrate or separate PEN substrates are automatically released from the substrate resulting in the functional intermediate transfer member or members as disclosed herein.

The disclosed intermediate transfer members are, in embodiments, weldable, that is the seam of the member, like a belt, is weldable, and more specifically, may be ultrasonically welded to produce a seam. The surface resistivity of the disclosed intermediate transfer member is, for example, from about 10⁹ to about 10¹³, or from about 10¹⁰ to about 10¹² ohm/sq. The sheet resistivity of the intermediate transfer weldable member is, for example, from about 10⁹ to about 10¹³, or from about 10¹⁰ to about 10¹² ohm/square.

The intermediate transfer members illustrated herein, like intermediate transfer belts, can be selected for a number of printing and copying systems, inclusive of xerographic printing. For example, the disclosed intermediate transfer members can be incorporated into a multi-imaging system where each image being transferred is formed on the imaging or photoconductive drum at an image forming station, wherein each of these images is then developed at a developing station, and transferred to the intermediate transfer member. The images may be formed on the photoconductor and developed sequentially, and then transferred to the intermediate transfer member. In an alternative method, each image may be formed on the photoconductor or photoreceptor drum, developed, and transferred in registration to the intermediate transfer member. In an embodiment, the multi-image system is a color copying system, wherein each color of an image being copied is formed on the photoreceptor drum, developed, and transferred to the intermediate transfer member.

After the toner latent image has been transferred from the photoreceptor drum to the intermediate transfer member, the intermediate transfer member may be contacted under heat and pressure with an image receiving substrate such as paper. The toner image on the intermediate transfer member is then transferred and fixed, in image configuration, to the substrate such as paper.

The intermediate transfer member is in close proximity to a xerographic photoconductor that permits a developed toner image to be transferred to the intermediate transfer member. Subsequently, the developed image is transferred from the intermediate transfer member to a substrate, like paper, and fixed thereto by heating. For the transfers, there can be selected a number of known processes, such as by the use of the appropriate devices that emit an electrical charge or a field of charges.

The intermediate transfer member present in the imaging systems illustrated herein, and other known imaging and printing systems, may be in the configuration of a sheet, a web, a belt, including an endless belt, an endless seamed flexible belt, and an endless seamed flexible belt; a roller, a film, a foil, a strip, a coil, a cylinder, a drum, an endless strip, and a circular disc. The intermediate transfer member can be comprised of a single layer, or can be comprised of several layers, such as from about 2 to about 5 layers. In embodiments, the intermediate transfer member further includes an outer release layer.

Release layer examples situated on and in contact with the fluorinated nano diamond layer include low surface energy materials such as TEFLON®-like materials including fluorinated ethylene propylene copolymer (FEP), polytetrafluoroethylene (PTFE), polyfluoroalkoxy polytetrafluoroethylene (PFA TEFLON®) and other TEFLON®-like materials; silicone materials such as fluorosilicones and silicone rubbers, such as Silicone Rubber 552, available from Sampson Coatings, Richmond, Va., (polydimethyl siloxane/dibutyl tin diacetate, 0.45 gram DBTDA per 100 grams polydimethyl siloxane rubber mixture, with a molecular weight M, of approximately 3,500); and fluoroelastomers, such as those sold as VITON®, such as copolymers and terpolymers of vinylidenefluoride, hexafluoropropylene, and tetrafluoroethylene, which are known commercially under various designations as VITON A®, VITON E®, VITON E60C®, VITON E45®, VITON E430®, VITON B910®, VITON GH®, VITON B50®, VITON E45®, and VITON GF®. The VITON® designation is a Trademark of E.I. DuPont de Nemours, Inc. Two known fluoroelastomers are comprised of (1) a class of copolymers of vinylidenefluoride, hexafluoropropylene, and tetrafluoroethylene, known commercially as VITON A®; (2) a class of terpolymers of vinylidenefluoride, hexafluoropropylene, and tetrafluoroethylene, known commercially as VITON B®; and (3) a class of tetrapolymers of vinylidenefluoride, hexafluoropropylene, tetrafluoroethylene, and a cure site monomer, such as VITON GF®, having 35 mole percent of vinylidenefluoride, 34 mole percent of hexafluoropropylene, and 29 mole percent of tetrafluoroethylene with 2 percent cure site monomer. The cure site monomer can be those available from E.I. DuPont de Nemours, Inc. such as 4-bromoperfluorobutene-1,1,1-dihydro-4-bromoperfluorobutene-1,3-bromoperfluoropropene-1,1,1-dihydro-3-bromoperfluoropropene-1, or any other suitable, known, commercially available cure site monomers.

The release layer or layers may be deposited on the substrate via well known coating processes. Known methods for forming the outer layer(s) on the substrate film, such as dipping, spraying such as by multiple spray applications of very thin films, casting, flow-coating, web-coating, roll-coating, extrusion, molding, or the like, can be used. Usually it is desirable to deposit the layers by spraying such as by multiple spray applications of very thin films, casting, by web coating, by flow-coating and most preferably by laminating.

The circumference of the intermediate transfer member, especially as it is applicable to a film or a belt configuration, is, for example, from about 250 to about 2,500 millimeters, from about 1,500 to about 2,500 millimeters, or from about 2,000 to about 2,200 millimeters with a corresponding width of, for example, from about 100 to about 1,000 millimeters, from about 200 to about 500 millimeters, or from about 300 to about 400 millimeters.

The referred to shell of the present disclosure contains in excess of at least 12 weight percent graphite, and more specifically, at least 15 weight percent graphite to achieve a number of the advantages illustrated herein. Therefore, the fluorine content plus the graphite content in the fluorinated graphite shell is about 100. More specifically, the amount of fluorine in the fluorinated graphite shell is from about 60 to about 85 weight percent, from about 65 to about 83 weight percent, from about 65 to about 80 weight percent, or from about 77 to about 73 weight percent, and where the amount of graphite in the shell is from about 15 to about 40 weight percent, from about 17 to about 35 weight percent, from about 20 to about 35 weight percent, or from about 23 to about 27 weight percent based on the ingredients of the graphite and the fluorine being equal to 100. Other amounts of fluorine and graphite may be selected for the shell providing the advantages of the present disclosure are achieved and the amount of graphite exceeds 12 weight percent.

Specific embodiments will now be described in detail. These examples are intended to be illustrative, and are not limited to the materials, conditions, or process parameters set forth in these embodiments. All parts are percentages by weight of total solids unless otherwise indicated.

### Comparative Example 1

### Preparation of Intermediate Transfer Member Comprised of Nano Diamond

One-half gram of a non-fluorinated nano diamond NB90 (90 weight percent of a diamond core and 10 weight percent of a graphite shell that fully, 100 percent, encapsulates the core), obtained from NANOBLOX Inc., was mixed with nine and half grams of a bisphenol-A-polycarbonate, MAKROLON® 5705, having a molecular weight average of from about 50,000 to about 100,000, commercially available from Farbenfabriken Bayer A.G., and 100 grams of methylene chloride. By ball milling this mixture with 2 millimeters of stainless shot overnight, 23 hours, a uniform dispersion was obtained. The dispersion was then coated on a biaxially oriented poly(ethylene naphthalate) (PEN) substrate (KALEDEX™ 2000) having a thickness of 3.5 mils using known draw bar coating methods. The resulting film was dried at about 120° C. for 1 minute while remaining on the PEN substrate. After drying and cooling to room temperature, the film on the PEN substrate was automatically released from the substrate resulting in a 50 micron thick intermediate transfer member of nano diamond/polycarbonate with a ratio by weight of 5/95.

### Comparative Example 2

### Preparation of Intermediate Transfer Member Comprised of Nano Diamond

One gram of a non-fluorinated nano diamond NB90 (90 weight percent of a diamond core and 10 weight percent of a graphite shell that fully, 100 percent, encapsulates the core), obtained from NANOBLOX Inc., was mixed with nine grams of a bisphenol-A-polycarbonate, MAKROLON® 5705, having a molecular weight average of from about 50,000 to about 100,000, commercially available from Farbenfabriken Bayer A.G., and 100 grams of methylene chloride. By ball milling this mixture with 2 millimeters of stainless shot overnight, 23 hours, a uniform dispersion was obtained. The dispersion was then coated on a biaxially oriented poly(ethylene naphthalate) (PEN) substrate (KALEDEX™ 2000) having a thickness of 3.5 mils using known draw bar coating methods. The resulting film was dried at about 120° C. for 1 minute while remaining on the PEN substrate. After drying and cooling to room temperature, the film on the PEN substrate was automatically released from the substrate resulting in a 50 micron thick intermediate transfer member of nano diamond/polycarbonate with a ratio by weight of 10/90.

### Example I

### Preparation of Intermediate Transfer Member Comprised of Fluorinated Nano Diamond

One-half gram of fluorinated nano diamond NB90-F (90 weight percent of a diamond core and 10 weight percent of a graphite shell that fully, 100 percent, encapsulates the core, which shell was about 70 percent fluorinated, and more specifically, which shell contains about 70 percent fluorine and about 30 percent graphite), obtained from NANOBLOX Inc., was mixed with nine and half grams of a bisphenol-A-polycarbonate, MAKROLON® 5705, having a molecular weight average of from about 50,000 to about 100,000, commercially available from Farbenfabriken Bayer A.G., and 100 grams of methylene chloride. By ball milling this mixture with 2 millimeters of stainless shot overnight, 23 hours, a uniform dispersion was obtained. The dispersion was then coated on a biaxially oriented poly(ethylene naphthalate) (PEN) substrate (KALEDEX™ 2000) having a thickness of 3.5 mils using known draw bar coating methods. The resulting film was dried at about 120° C. for 1 minute while remaining on the PEN substrate. After drying and cooling to room temperature, the film on the PEN substrate was automatically released from the substrate resulting in a 50 micron thick intermediate transfer member of fluorinated nano diamond/polycarbonate with a ratio by weight of 5/95.

### Example II

### Preparation of Intermediate Transfer Member Comprised of Fluorinated Nano Diamond

One gram of fluorinated nano diamond NB90-F (90 weight percent of a diamond core and 10 weight percent of a graphite shell that fully, 100 percent, encapsulates the core, which shell was about 70 percent fluorinated, and more specifically, which shell contains about 70 percent fluorine and about 30 percent graphite), obtained from NANOBLOX Inc., was mixed with nine grams of a bisphenol-A-polycarbonate, MAKROLON® 5705, having a molecular weight average of from about 50,000 to about 100,000, commercially available from Farbenfabriken Bayer A.G., and 100 grams of methylene chloride. By ball milling this mixture with 2 millimeters of stainless shot overnight, 23 hours, a uniform dispersion was obtained. The dispersion was then coated on a biaxially oriented poly(ethylene naphthalate) (PEN) substrate (KALEDEX™ 2000) having a thickness of 3.5 mils using known draw bar coating methods. The resulting film was dried at about 120° C. for 1 minute while remaining on the PEN substrate. After drying and cooling to room temperature, the film on the PEN substrate was automatically released from the substrate resulting in a 50 micron thick intermediate transfer member of fluorinated nano diamond/polycarbonate with a ratio by weight of 5/95.

### Surface Resistivity Measurement

The above ITB members or devices of Comparative Examples 1 and 2, and Examples I and II were measured for surface resistivity (averaging four to six measurements at varying spots, 72° F./65 percent room humidity) using a High Resistivity Meter (Hiresta-Up MCP-HT450 from Mitsubishi Chemical Corp.). The results are provided in Table 1.

TABLE 1

| | Surface | Contact | |
|---|---|---|---|
| | Resistivity | Angle | Friction |
| | (ohm/sq) | (°) | Coefficient |
| Comparative Example 1 | (2.08 ± 0.12) × 10¹³ | 77 ± 2 | 0.41 ± 0.01 |
| with 5 Weight Percent of | | | |
| Nano Diamond | | | |
| Comparative Example 2 | (2.65 ± 0.18) × 10¹¹ | 78 ± 1 | 0.40 ± 0.01 |
| with 10 Weight Percent of | | | |
| Nano Diamond | | | |
| Example I | (3.14 ± 0.15) × 10¹² | 83 ± 2 | 0.36 ± 0.01 |
| with 5 Weight Percent of | | | |
| Fluorinated Nano Diamond | | | |
| Example II | (7.36 ± 0.21) × 10⁹ | 84 ± 1 | 0.35 ± 0.00 |
| with 10 Weight Percent of | | | |
| Fluorinated Nano Diamond | | | |

The disclosed ITB devices (Examples I and II) comprising the fluorinated nano diamond were about 1 order of magnitude less resistive than those comprising the nano diamond (Comparative Examples 1 and 2). Fluorination of the nano diamond thus rendered the resulting particles and ITB members less resistive.

### Contact Angle Measurement

The advancing contact angles of water (in deionized water) on the ITB devices of Comparative Examples 1 and 2, and Examples I and II were measured at ambient temperature (about 23° C.), using the Contact Angle System OCA (Dataphysics Instruments GmbH, model OCA15. At least ten measurements were performed, and their averages are reported in Table 1.

The disclosed ITB devices (Examples I and II) comprising the fluorinated nano diamond exhibited higher contact angles than those comprising the nano diamond (Comparative Examples 1 and 2). Fluorination of the nano diamond thus rendered these particles and the resulting ITB more hydrophobic.

### Friction Coefficient Measurement

Friction coefficients were measured for the ITB devices of Comparative Examples 1 and 2, and Examples I and II as follows, and the results are provided in Table 1. The coefficient of kinetic friction of a sample film against polished stainless steel surface was measured by COF Tester (Model D5095D, Dynisco Polymer Test, Morgantown, Pa.) according to ASTM D1894-63, procedure A. The tester was facilitated with a 2.5″×2.5″, 200 gram weight with rubber on one side, a moving polished stainless steel sled, and a DFGS force gauge (250 gram max.). The sample film was cut into a 2.5″×3.5″ piece, and taped onto the 200 gram weight on the rubber side with the surface to be tested facing the sled. The coefficient of kinetic friction is defined as the ratio of the kinetic friction force (F) between the surfaces in contact to the normal force: F/N, where F was measured by the gauge and N is the weight (200 grams). The measurements were conducted at the sled speed of 6″/minute and at ambient conditions. The result was reported as the average of three measurements.

The disclosed ITB devices (Examples I and II) comprising the fluorinated nano diamond exhibited about a 15 percent lower friction coefficient than those of nano diamond (Comparative Examples 1 and 2). The fluorinated nano diamond thus provided these particles and the ITB surface with excellent slippery characteristics.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others. Unless specifically recited in a claim, steps or components of claims should not be implied or imported from the specification or any other claims as to any particular order, number, position, size, shape, angle, color, or material.

What is claimed is:

1. A xerographic intermediate transfer member comprised of a fluorinated nano diamond of a diamond core and a fluorinated graphite shell thereover, and an optional polymer binder, and wherein said shell contains from about 60 to about 85 weight percent of fluorine and from about 15 to about 40 weight percent of graphite.

2. An intermediate transfer member in accordance with claim 1 wherein said fluorinated nano diamond has a diameter of from about 3 to about 1,000 nanometers, said shell fully encapsulates said core, and wherein said graphite is present in an amount of from about 60 to about 85 weight percent.

3. An intermediate transfer member in accordance with claim 1 wherein said fluorinated nano diamond has a diameter of from about 15 to about 200 nanometers.

4. An intermediate transfer member in accordance with claim 1 wherein said fluorinated nano diamond has a diameter of from about 30 to about 100 nanometers, and wherein said fluorine is present in an amount of from about 65 to about 83 weight percent, and said graphite is present in an amount of from about 17 to about 35 weight percent.

5. An intermediate transfer member in accordance with claim 1 wherein said diamond core is present in an amount of from about 20 to about 99.9 weight percent, and said shell possesses a graphite content of at least 15 weight percent.

6. An intermediate transfer member in accordance with claim 1 wherein said diamond core is present in an amount of from about 50 to about 98 weight percent, and said fluorinated nano diamond possesses a fluorine content of from about 65 to about 85 weight percent.

7. An intermediate transfer member in accordance with claim 1 wherein said fluorinated nano diamond is formed by reacting nano diamond with fluorine, and wherein said fluorinated nano diamond is spherical in shape.

8. An intermediate transfer member in accordance with claim 1 wherein said fluorinated nano diamond is present in an amount of from about 1 to about 30 weight percent.

9. An intermediate transfer member in accordance with claim 1 wherein said fluorinated nano diamond is present in an amount of from about 5 to about 20 weight percent, and wherein said fluorine amount is from about 65 to about 85 weight percent, and said graphite amount is from about 20 to about 35 weight percent.

10. An intermediate transfer member in accordance with claim 1 wherein said graphite amount is from about 20 to about 35 weight percent.

11. An intermediate transfer member in accordance with claim 1 further including a polyaniline present in an amount of from about 1 to about 30 percent by weight.

12. An intermediate transfer member in accordance with claim 1 further including a carbon black present in an amount of from about 1 to about 30 percent by weight.

13. An intermediate transfer member in accordance with claim 1 wherein said fluorinated nano diamond is dispersed in said polymer binder of at least one of a polyimide, a polycarbonate, a polyester, a poly(butylene terephthalate), a poly(ethylene terephthalate), a poly(ethylene naphthalate), a polyvinylidene fluoride, a polysulfone, a polyetherimide, a polyamideimide, and a polyethylene-co-polytetrafluoroethylene, and wherein the ratio of said fluorinated nano diamond to said polymer of at least one of a polyimide, a polycarbonate, a polyester, a poly(butylene terephthalate), a poly(ethylene terephthalate), a poly(ethylene naphthalate), a polyvinylidene fluoride, a polysulfone, a polyetherimide, a polyamideimide, and a polyethylene-co-polytetrafluoroethylene is from about 3/97 to about 20/80.

14. An intermediate transfer member in accordance with claim 1 wherein said member has a surface resistivity of from about 10⁸ to about 10¹³ ohm/square.

15. An intermediate transfer member in accordance with claim 1 wherein said surface resistivity is from about 10¹⁰ to about 10¹² ohm/square, a water contact angle of from about 80 to about 90 degrees, and a coefficient of from about 25 to about 35.

16. An intermediate transfer member in accordance with claim 1 further comprising an outer release layer positioned on said member, and wherein said release layer comprises a fluorinated ethylene propylene copolymer, a polytetrafluoroethylene, a polyfluoroalkoxy polytetrafluoroethylene, a fluorosilicone, a terpolymer of vinylidene fluoride, hexafluoropropylene and tetrafluoroethylene, and mixtures thereof.

17. An intermediate transfer member in accordance with claim 1 wherein said intermediate transfer member has a circumference of from about 250 to about 2,500 millimeters, a water contact angle of from about 80 to about 85 degrees, and a coefficient of from about 30 to about 35.

18. An intermediate transfer member consisting of a conductive carbon black component, and a diamond core and a fluorinated graphite shell thereover that encapsulates said core, and wherein said shell contains from about 60 to about 85 weight percent of fluorine and from about 15 to about 40 weight percent of graphite, and wherein the total of said components of said fluorine and said graphite is equal to about 100.

19. An intermediate transfer member in accordance with claim 18 wherein said shell contains from about 65 to about 80 weight percent of fluorine and from about 20 to about 35 weight percent of graphite, and which member has transferred thereto from a photoconductor a xerographic toner developed image.

20. An intermediate transfer member consisting of a supporting substrate and thereover a coating consisting of a mixture of a conductive component of carbon black or a polyaniline, and a fluorinated nano diamond, wherein said fluorinated nano diamond consists of a synthetic diamond core and a fluorinated graphite shell, and wherein said fluorinated nano diamond possesses a fluorine content of from about 60 to about 85 weight percent, and which member has a water contact angle of from about 80 to about 90 degrees and a friction coefficient of from about 25 to about 35.
